(19) United States
(12) Patent Application Publication
(10) Pub. No.: US 2003/0142781 A1
(43) Pub. Date: Jul. 31, 2003

(54) X-ray fluorescence spectrometer for semiconductors

(76) Inventors: Naoki Kawahara, Osaka (JP); Hisayuki Kohno, Osaka (JP); Takashi Yamada, Osaka (JP); Keisuke Ogura, Osaka (JP)

Correspondence Address: BIRCH STEWART KOLASCH & BIRCH, PO BOX 747, FALLS CHURCH, VA, 22040-0747, US

(21) Appl. No.: 10/353,964

(22) Filed: Jan. 30, 2003

(30) Foreign Application Priority Data
Jan. 31, 2002 (JP) 2002-023337
Dec. 27, 2002 (JP) 2002-381325

(51) Int. Cl. G01T 1/36

(52) U.S. Cl. 378/44

(57) ABSTRACT

To provide an X-ray fluorescence spectrometer capable of analyzing a semiconductor sample at inexpensive costs non-invasively without incurring damage to the patterned circuits on the semiconductor sample, the X-ray fluorescence spectrometer includes a point source of primary X-rays 3a for emitting primary X-rays B1 used to irradiate a semiconductor sample 1 having circuit patterned areas 1a and scribe line 1b so as to separate the neighboring circuit patterned areas 1a, and a detecting unit 5 for detecting fluorescent X-rays emitted from the semiconductor sample 1. The X-ray fluorescence spectrometer also includes a focusing element 6 for focusing the primary X-rays B1 to form a spot irradiation region of a diameter not greater than 50 μm, a sample recognizing unit 12 for recognizing the scribe line on the semiconductor sample as a target site of measurement, and a positioning mechanism 15 for moving the scribe line 1b on the semiconductor sample to a measurement position where the primary X-rays B1 are focused.

### BACKGROUND OF THE INVENTION

1. Field of the Invention

The present invention generally relates to an X-ray fluorescence spectrometer for analyzing a semiconductor formed with a circuit pattern and, more particularly, to minimization of damages to the circuit pattern on the semiconductor sample which would be brought about when irradiated with primary X-rays.

2. Description of the Prior Art

An X-ray fluorescence spectrometer for analyzing a semiconductor sample or wafer formed with a plurality of separate patterned circuits, by irradiating the semiconductor sample with primary X-rays emitted from an X-ray source has long been well known in the art. An example of such X-ray fluorescence spectrometer is disclosed in, for example, the Japanese Laid-open Patent Publication No. 2002-214166.

It has, however, been found that since an area of the semiconductor wafer irradiated with the primary X-rays emitted from the X-ray source during measurement of the semiconductor wafer is relatively large, some of the circuit patterned areas on the semiconductor wafer tend to be irradiated with the primary X-rays, resulting in damage to such circuit patterned areas. Once this occurs, damaged circuit patterned areas on the semiconductor wafer or the whole wafer can no longer be used for circuit chips for shipment.

Because of the reason discussed above, for a semiconductor wafer for measurement purpose a dummy semiconductor wafer that cannot be used as a wafer product, but can be used only for measurement purpose is needed. However, considering that semiconductor wafers being currently manufactured has an increased size or diameter with concomitant increase of the per-piece cost of the semiconductor wafer, the use of dummy semiconductor wafers solely for measurement purpose is indeed incongruous with the cost-effectiveness.

### SUMMARY OF THE INVENTION

In view of the foregoing, the present invention has been aimed at solving the above discussed problems and is intended to provide an X-ray fluorescence spectrometer capable of analyzing a semiconductor sample at inexpensive costs non-invasively without incurring damage to the patterned circuits on the semiconductor sample.

In order to accomplish the above discussed object, the present invention in accordance with one aspect thereof provides an X-ray fluorescence spectrometer which includes a point source of primary X-rays for emitting primary X-rays used to irradiate a semiconductor sample having circuit patterned areas and scribe line so as to separate the neighboring circuit patterned areas, and a detecting unit for detecting fluorescent X-rays emitted from the semiconductor sample. The X-ray fluorescence spectrometer also includes a focusing element for focusing the primary X-rays to form a spot irradiation region of a diameter not greater than 50 μm, a sample recognizing unit for recognizing the scribe line on the semiconductor sample as a target site of measurement, and a positioning mechanism for moving the scribe line on the semiconductor sample to a measurement position where the primary X-rays are focused.

With the X-ray fluorescence spectrometer according to the foregoing aspect of the present invention, the scribe line of the semiconductor sample can be recognized as a target site of measurement and can be so positioned by the positioning mechanism that only the scribe line of the semiconductor sample can be irradiated with the primary X-rays which have been converged by the focusing element to a spot size not greater than 50 μm. With the scribe line of the semiconductor sample so measured in the manner described above, the semiconductor sample can be analyzed non-invasively without the circuit patterned areas being detrimentally damaged by irradiation with the primary X-rays, and at an inexpensive cost with no need to use a dedicated semiconductor sample hitherto required solely for the purpose of measurement.

In a preferred embodiment of the present invention, the focusing element may be a poly-capillary. The poly-capillary herein referred to is made up of a plurality of slender tubes such as, for example, glass tubes bundled together, with the outer diameter of an X-ray emission end thereof progressively decreasing in a direction conforming to the direction of emission of the X-rays away from the source of primary X-rays so that X-rays emitted from the source of primary X-rays and subsequently incident on the semiconductor sample can be finely converged.

In another preferred embodiment of the present invention, the focusing element may be a mirror or spectroscopic device having a reflecting surface of a spheroidal or troidal shape.

Alternatively, the focusing element may include two mirrors or spectroscopic devices arranged to form a Kirkpatrick-Baez type focusing optics. While the Kirkpatrick-Baez type focusing optics is well known to those skilled in the art, the details thereof will be discussed subsequently.

The present invention in accordance with another aspect thereof provides an X-ray fluorescence spectrometer including a source of primary X-rays (which may be either a point source or a line source) for emitting primary X-rays used to irradiate a semiconductor sample having circuit patterned areas and scribe line so as to separate the neighboring circuit patterned areas, a detecting unit for detecting fluorescent X-rays emitted from the semiconductor sample, a focusing element for focusing the primary X-rays to form an irradiation region of a width not greater than 50 μm, a sample -recognizing unit for recognizing the scribe line on the semiconductor sample as a target site of measurement, and a positioning mechanism for moving the scribe line on the semiconductor sample to a measurement position where the primary X-rays are focused.

With the X-ray fluorescence spectrometer according to such another aspect of the present invention, the scribe line of the semiconductor sample can be recognized as a target site of measurement and can be so positioned by the positioning mechanism that only the scribe line of the semiconductor sample can be irradiated with the primary X-rays which have been converged by the focusing element to a line irradiation region of a width not greater than 50 μm. With the scribe line of the semiconductor sample so measured in the manner described above, the semiconductor sample can be analyzed non-invasively without the circuit patterned areas being detrimentally damaged by irradiation with the primary X-rays, and at an inexpensive cost with no need to use a dedicated semiconductor sample hitherto required solely for the purpose of measurement.

Preferably, the focusing element may be a mirror having a reflecting surface of a shape selected from the group consisting of an elliptic cylinder, a cylinder and a sphere. Alternatively, the focusing element may be a spectroscopic device having a reflecting surface of an elliptic cylindrical shape or a cylindrical shape.

In accordance with a third aspect of the present invention, there is provided an X-ray fluorescence spectrometer which includes a point source of primary X-rays for emitting primary X-rays used to irradiate a semiconductor sample having circuit patterned areas and scribe line so as to separate the neighboring circuit patterned areas, a detecting unit for detecting fluorescent X-rays emitted from the semiconductor sample, a focusing element for focusing the primary X-rays to form a crisscross irradiation region having two line segments crossing at right angles to each other, each of said line segments having a width not greater than 50 μm, a sample recognizing unit for recognizing the scribe line on the semiconductor sample as a target site of measurement, and a positioning mechanism for moving the scribe line on the semiconductor sample to a measurement position where the primary X-rays are focused.

With the X-ray fluorescence spectrometer constructed according to the third aspect of the present invention, the scribe line of the semiconductor sample can recognized as the target site of measurement and can be so positioned by the positioning mechanism that only the scribe line of the semiconductor sample can be irradiated with the primary X-rays which have been converged by the focusing element to the crisscross irradiation region of a line size not greater than 50 μm. With the scribe line of the semiconductor sample so measured in the manner described above, the semiconductor sample can be analyzed non-invasively without the circuit patterned areas being detrimentally damaged by irradiation with the primary X-rays, and at an inexpensive cost with no need to use a dedicated semiconductor sample hitherto required solely for the purpose of measurement.

In such case, the focusing element may preferably include two pairs of opposed mirrors arranged with a direction of confrontation of the opposed mirrors of one pair lying perpendicular to a direction of confrontation of the opposed mirrors of the other pair. Each of those mirrors has a reflecting surface of a shape selected from the group consisting of an elliptic cylinder, a cylinder and a sphere. Alternatively, the focusing element may include two pairs of opposed spectroscopic devices arranged with a direction of confrontation of the opposed spectroscopic devices of one pair lying perpendicular to a direction of confrontation of the opposed spectroscopic devices of the other pair. Even each of those spectroscopic devices has a reflecting surface of an elliptic cylindrical shape or a cylindrical shape.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic diagram showing an X-ray fluorescence spectrometer for semiconductors constructed in accordance with a first preferred embodiment of the present invention;

FIG. 2 is a schematic plan view showing a portion of a semiconductor wafer that is used as a sample to be analyzed;

FIG. 3A is a schematic diagram showing a modified form of the X-ray fluorescence spectrometer according to the first embodiment of the present invention and, also, the X-ray fluorescence spectrometer constructed in accordance with a second preferred embodiment of the present invention;

FIG. 3B is a schematic plan view showing a primary X-ray irradiation region converged on a semiconductor wafer surface in the X-ray fluorescence spectrometer according to the second embodiment of the present invention;

FIG. 4 is a schematic diagram showing another modified form of the X-ray fluorescence spectrometer according to the first embodiment of the present invention;

FIG. 5 is a schematic diagram showing a Kirkpatrick-Baez type focusing optics used as a two-dimensional focusing element in a further modified form of the X-ray fluorescence spectrometer according to the first embodiment of the present invention;

FIG. 6A is a schematic diagram showing the X-ray fluorescence spectrometer constructed in accordance with a third preferred embodiment of the present invention;

FIG. 6B is a schematic plan view showing a primary X-ray irradiation region converged on a semiconductor wafer surface in the X-ray fluorescence spectrometer according to the third embodiment of the present invention;

FIG. 7A is a schematic diagram showing the focusing element used in the X-ray fluorescence spectrometer according to the third embodiment of the present invention; and

FIG. 7B is a schematic diagram showing one of top and bottom surfaces of a casing in which the focusing element shown in FIG. 7A is accommodated.

### DETAILED DESCRIPTION OF THE EMBODIMENTS

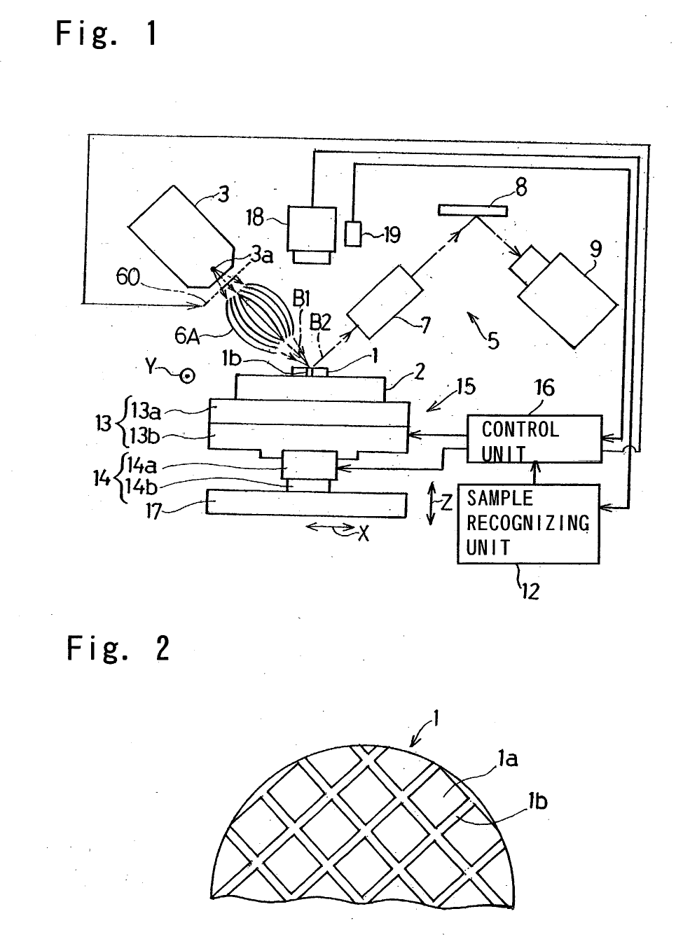

Hereinafter, some preferred embodiments of the present invention will be described in detail with reference to the accompanying drawings. In particular, FIG. 1 illustrates a schematic diagram of an X-ray fluorescence spectrometer for semiconductor samples, for example, semiconductor wafers constructed in accordance with a first preferred embodiment of the present invention. Referring to FIG. 1, the X-ray fluorescence spectrometer shown therein includes a sample support or table 2 on which a semiconductor sample 1 (for example, a semiconductor wafer) is placed, an X-ray tube 3 having a point source of primary X-rays 3a (a point focus on a target) for irradiating a surface of the semiconductor wafer 1 with primary X-rays B1, and a detecting unit 5 for measuring the intensity of fluorescent X-rays B2 emitted from the semiconductor wafer 1. The detecting unit 5 referred to above includes a soller slit 7 for collimating the X-rays, a spectroscopic device 8, a detector 9, a goniometer (not shown), and other components.

FIG. 2 illustrates a fragmentary plan view showing a portion of the semiconductor wafer 1 that is to be measured by the X-ray fluorescence spectrometer of the structure shown in FIG. 1. As shown therein, the semiconductor wafer 1 may be of a round configuration having a plurality of circuit patterned areas 1a, each having an electronic circuit pattern formed thereon, and a generally matrix-patterned scribe line 1b along which the semiconductor wafer 1 is cut to provide semiconductor chips each defined by the respective circuit patterned area 1a. This matrix-patterned scribe line 1b has a plurality of scribe rows and a plurality of scribe columns perpendicular to the scribe rows, each of said scribe rows and columns having a width within the range of, for example, 80 to 100 μm. The X-ray fluorescence spectrometer embodying the present invention is so designed and so operated as to measure the thickness of, and analyze the composition of, a film of the semiconductor wafer 1 based on the intensity of the fluorescent X-rays B2 that are generated from the scribe line 1b when the scribe line 1b of the semiconductor wafer 1 is irradiated with the primary X-rays B1.

The illustrated fluorescence X-ray fluorescence spectrometer also includes a poly-capillary 6A disposed as a two-dimensional focusing element (having two point foci) disposed on a path of travel of X-rays between the X-ray tube 3 and the semiconductor wafer 1 as shown in FIG. 1. The poly-capillary 6A has an X-ray incident end and an X-ray emission end opposite to the incident end and is made up of a plurality of slender tubes such as, for example, glass tubes bundled together, with the outer diameter of the X-ray emission end progressively decreasing in a direction conforming to the direction of emission of the X-rays away from the X-ray tube 3 so that X-rays emitted from the source of primary X-rays 3a can be converged into a needle (spot) shape of the primary X-rays B1. In view of the width of the scribe columns and rows discussed above, an irradiation region that is irradiated with the primary X-rays B1 emerging outwardly from the poly-capillary 6A must be of such a size that the primary X-rays B1 can be converged to form a spot of not greater than 80 μm in diameter and preferably not greater than 50 μm in diameter on a surface of the scribe line 1b.

The X-ray fluorescence spectrometer embodying the present invention again includes an imaging unit such as, for example, a CCD camera for imaging the semiconductor wafer 1 placed on the sample support 2, and a sample recognizing unit 12 having any known image processing unit for processing an image of the semiconductor wafer 1, which is generated by the imaging unit 18, and capable of recognizing as a target site of measurement the scribe line 1b separating the circuit patterned areas 1a on the semiconductor wafer 1. The surface shape and the position of the scribe line 1b on the semiconductor wafer 1 can be recognized as a two-dimensional image data on the X-Y coordinate system. Also, since in order for the point of convergence of the primary X-rays B1 to be brought in coincidence with the surface of the semiconductor wafer 1, a height data of the semiconductor wafer 1 is required, the use is made of a height measuring unit 19 such as, for example, a laser displacement gauge for measuring the height of the semiconductor wafer 1. It is, however, to be noted that the imaging unit 18 and the height measuring unit 19 may be a component part separate from the X-ray fluorescence spectrometer so that at a remote place the semiconductor wafer 1 can be imaged and the height thereof can be measured.

In addition, the X-ray fluorescence spectrometer includes a positioning mechanism 15 for bringing the scribe line 1b on the semiconductor wafer 1 to a measurement position at which the irradiation region (of a size not greater than 50 μm in spot size) can be irradiated with the primary X-rays B1, and a control unit 16 for controlling the spectrometer in its entirety.

The positioning mechanism 15 referred to above is comprised of an X-Y stage 13 for moving the sample support 2 in X-axis and Y-axis directions perpendicular to each other and a Z stage 14 for moving the sample support 2 up and down in a Z-axis direction perpendicular to the plane containing the X-axis and Y-axis directions. More specifically, the X-Y stage 13 includes a lower portion 13b and an upper portion 13a mounted on the lower portion 13b for movement left and right in the X-axis direction relative to the lower portion 13b. While the sample support 2 is fixedly mounted on the upper portion 13a of the X-Y stage 13 of the positioning mechanism 15 for movement together therewith, the lower portion 13b thereof is mounted on an upper portion 14a, forming a part of the Z stage 14, for movement in the Y-axis direction relative to the upper portion 14a of the Z-axis stage 14. The upper portion 14a of the Z-axis stage 14 is in turn mounted on a Z-axis stage lower portion 14b for movement up and down in the Z-axis direction relative to the lower portion 14b. This lower portion 14b of the Z-axis stage 14 is fixedly mounted on a base 17 positioned therebelow.

The X-Y stage 13 and the Z stage 14 are controlled by the control unit 16. Specifically, the control unit 16, based on the image data on the scribe line 1b of the semiconductor wafer 1, recognized by the sample recognizing unit 12, and the height data on the semiconductor wafer 1 provided by the height measuring unit 19, controls the X-Y stage 13 and the Z stage 14 so that the sample support 2 can be moved to the position where the point focus of the primary X-rays B1 which has been converged to a size not greater than 50 μm can be projected onto the surface of the scribe line 1b of the semiconductor wafer 1.

In order to avoid each of the circuit patterned areas 1a on the semiconductor wafer 1 from being irradiated with the primary X-rays B1, a shutter 60 is provided. While it is desirable to position the shutter 60 at a location between the poly-capillary (the focusing element) 6A and the semiconductor wafer (sample) 1, it may be positioned at a location between the X-ray tube 3 and the poly-capillary 6A where no space is available to position the shutter 60 between the poly-capillary 6A and the semiconductor wafer 1. The shutter 60 is adapted to be selectively advanced into or withdrawn from the path of travel of the X-rays away from the source of primary X-rays 3a, that is, to selectively open or close such path by means of any known actuating mechanism utilizing, for example, a drive motor. The selective opening or closure of the shutter 60 is controlled by the control unit 16 such that the path of travel of the X-rays from the source of primary X-rays 3a can be opened only when the scribe line 1b of the semiconductor wafer 1 is moved to the measurement position where it is irradiated with the primary X-rays B1 and, hence, measurement is carried out. It is, however, to be noted that in place of the use of the shutter 60, the X-ray tube 3 may be so controlled as to be switched on and off selectively, but the use of the shutter 60 is rather desirable since the primary X-rays B1 emitted by the X-ray tube 3 would fluctuate each time the X-ray tube 3 is switched on.

The operation of the X-ray fluorescence spectrometer of the structure described above will now be described. At the outset, as shown in FIG. 1, the semiconductor wafer 1 is placed on the sample support 2 in alignment with a center of such sample support 2. Thereafter, the semiconductor wafer 1 is imaged by the imaging unit 18 to obtain an image of the semiconductor wafer 1. The image so obtained is processed in any known manner by any known image processing unit and the scribe line 1b between the neighboring circuit patterned areas 1a on the semiconductor wafer 1 is subsequently recognized by the sample recognizing unit 12 as a two-dimensional image data on the X-Y coordinate system. The height data on the semiconductor wafer 1 is also obtained from the height measuring unit 19.

Thereafter, based on the two-dimensional image data on the scribe line 1b of the semiconductor wafer 1 recognized by the sample recognizing unit 12 and the height data on the semiconductor wafer 1, the control unit 16 controls the positioning mechanism 15 to bring the sample support 2 to the position where the point focus of the primary X-rays B1 which has been converged to a size not greater than 50 μm can be projected onto the surface of the scribe line 1b of the semiconductor wafer 1. Since the scribe line 1b of the semiconductor wafer 1 has a width within the range of 80 to 100 μm, the point focus of the primary X-rays B1 having been converged to a size not greater than 50 μm can irradiate only the scribe line 1b of the semiconductor wafer 1. In this condition, the shutter 60 is opened to allow the scribe line 1b of the semiconductor wafer 1 to be exposed to the incoming primary X-rays B1 and, therefore, based on the intensity of the fluorescent X-rays B2 emitted from the scribe line 1b, the thickness and the composition of the film of the semiconductor wafer 1 can be eventually analyzed.

As discussed above, with the X-ray fluorescence spectrometer according to the first embodiment of the present invention, the scribe line 1b of the semiconductor wafer 1 is recognized as the target site of measurement and the scribe line 1b of the semiconductor wafer 1 is so positioned by the positioning mechanism 15 that only the scribe line 1b of the semiconductor wafer 1 can be irradiated with the primary X-rays B1 which have been converged by the poly-capillary 6A to a spot size not greater than 50 μm. With the scribe line 1b of the semiconductor wafer 1 so measured in the manner described above, the semiconductor wafer 1 can be analyzed non-invasively without the circuit patterned areas 1a being detrimentally damaged by irradiation with the primary X-rays B1, and at an inexpensive cost with no need to use a dedicated semiconductor sample hitherto required solely for the purpose of measurement.

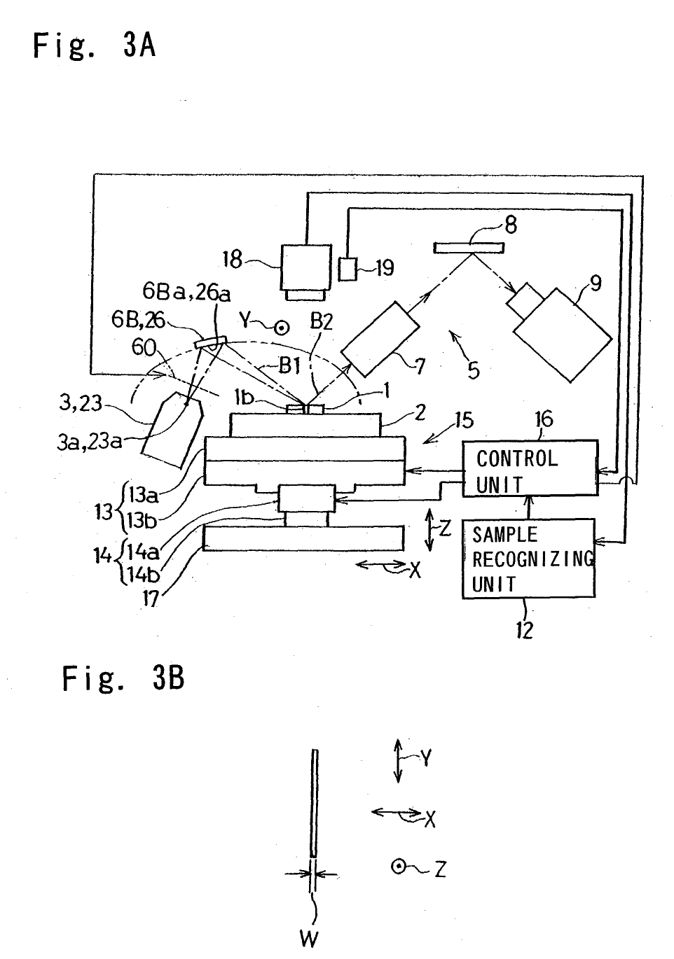

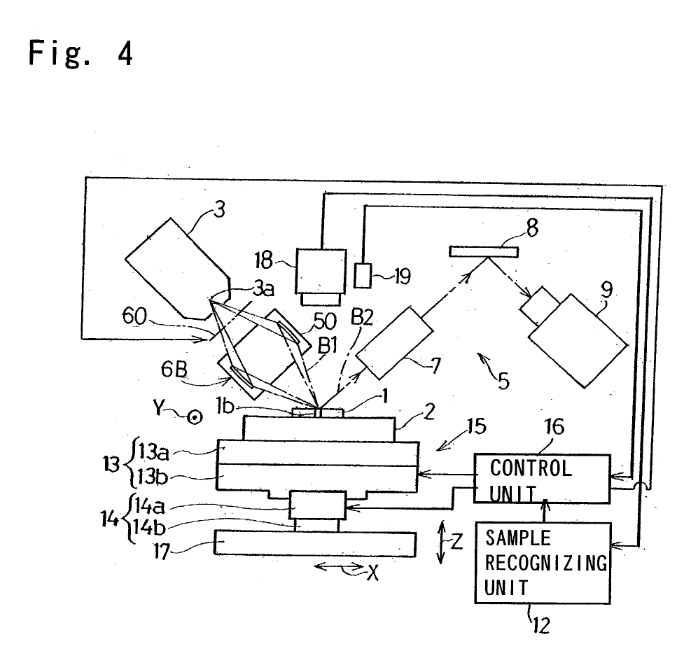

In the foregoing description, the two-dimensional focusing element has been described as employed in the form of the poly-capillary 6A. However, in place of the poly-capillary 6A, a mirror or spectroscopic device 6B having a spheroidal surface (ellipsoid of revolution) or a troidal surface (toric surface) approximating to the spheroidal surface may be employed. By way of example, the use of the mirror 6B is shown in FIG. 3A, which mirror 6B has a reflecting surface 6Ba of a shape occupying a portion of the circumference of the spheroid about a major axis thereof (although in FIG. 3A the mirror 6B is shown in section). This mirror 6B having the spheroidal reflecting surface 6Ba is so positioned and so oriented as to reflect the X-rays originating from the point source of primary X-rays 3a (one of the foci) so as to be converged on the surface (the other of the foci) of the scribe line 1B of the semiconductor wafer 1, then held at the measurement position, as the primary X-rays B1.

Where the mirror 6B is employed of a design in which the entire circumference of the spheroid about the major axis thereof is utilized to define the reflecting surface, such mirror 6B is encased within a casing 50 of, for example, a cylindrical shape as shown in FIG. 4. In such case, the cylindrical casing 50 has top and bottom surfaces each provided with a shielding plate having a ring-shaped window (slit) to avoid the X-rays, emitted by the source of primary X-rays 3a, from irradiating the semiconductor wafer 1 directly without being reflected. On the other hand, where the spectroscopic device 6B, not the mirror, is employed, reflection occurring at the reflecting surface 6Ba will represent a Bragg reflection and, accordingly, the primary X-rays B1 can be converged by the effect of diffraction and will at the same time be monochromated.

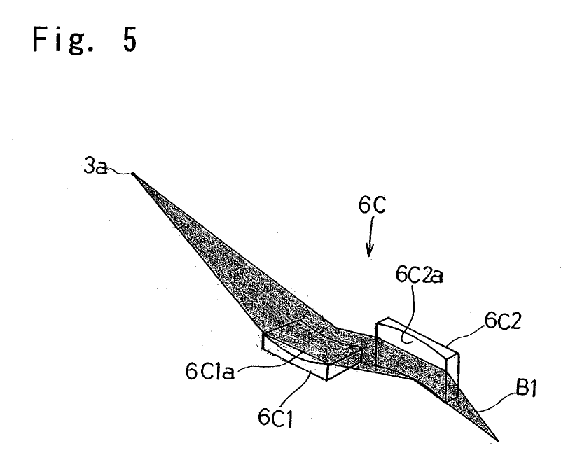

Also, for the two-dimensional focusing element in the practice of the first embodiment of the present invention, two mirrors or spectroscopic devices 6C forming such a Kirkpatrick-Baez type focusing optics as shown in FIG. 5 may be employed. The Kirkpatrick-Baez type focusing optics is of a design wherein two mirrors or spectroscopic devices 6C1 and 6C2 having respective elliptic cylindrical reflecting surfaces 6C1a and 6C2a are arranged in series with each other in a direction conforming to the direction of travel of the X-rays from the source of primary X-rays 3a, having been twisted 90° relative to each other. Such focusing element 6C is well known to those skilled in the art and, therefore, the details thereof will not be reiterated for the sake of brevity.

The X-ray fluorescence spectrometer according to a second embodiment of the present invention will now be described. In the X-ray fluorescence spectrometer according to this embodiment shown in FIG. 3A, the two-dimensional focusing element 6 used in the practice of the first embodiment is replaced with one-dimensional focusing element 26 (having two line foci) of a type capable of converging the primary X-rays B1 to define a line having a width not greater than 50 μm. Consequent upon the use of the one-dimensional focusing element 26 discussed above, a source of primary X-rays employed therein may be similar to the point source of primary X-rays 3a such as used in the practice of the previously described embodiment. However, in order to secure a sufficient intensity of the primary X-rays B1 that irradiate the scribe line 1b of the semiconductor wafer 1, it is preferred to use a line source of primary X-rays 23a (line focus on a target of the X-ray tube 23 having an effective focus size (the width as viewed from the focusing element 26) that is not greater than 50 μm and extends in a direction perpendicular to the plane of the sheet of the drawing). Other structural features of the X-ray fluorescence spectrometer according to the second embodiment are similar to those of the X-ray fluorescence spectrometer according to the first embodiment and, accordingly, the details thereof will not be reiterated for the sake of brevity.

The one-dimensional focusing element 26 that can be employed in the X-ray fluorescence spectrometer according to the second embodiment may be a mirror or spectroscopic device 26 having a reflecting surface 26a of an elliptic cylindrical shape or a cylindrical shape approximating to the elliptic cylindrical shape. Where the one-dimensional focusing element 26 is employed in the form of the mirror and the X-rays from the source of primary X-rays 23a undergoes a total reflection when impinging upon the reflecting surface 26a because of a small angle of incidence thereof on the reflecting surface 26a, the shape of the reflecting surface 26 may be a sphere approximating to the elliptic cylinder. By way of example, the one-dimensional focusing element 26 in the form of the mirror having the elliptic cylindrical reflecting surface 26a is of such a design in which the reflecting surface 26a occupies a portion of an elliptic cylinder that extends in a direction perpendicular to the plane of the sheet of the drawing, and is so positioned that the X-rays emitted from the line source of primary X-rays 23a (one of the foci) can, after having been reflected by the elliptic cylindrical reflecting surface 26a, be converged as the primary X-rays B1 at the surface (the other of the foci) of the scribe line 1b of the semiconductor wafer 1 then held at the measurement position. The primary X-rays B1 emitted from the line source of primary X-rays 23a and subsequently reflected by the elliptic cylindrical reflecting surface 26a are converged at the surface of the scribe line 1b of the semiconductor wafer 1, where they are focused, to a beam width W (the width of the line irradiation region) that is approximately equal to the effective focus size of the line source of primary X-rays 23a.

As discussed above, with the X-ray fluorescence spectrometer according to the second embodiment, the scribe line 1b of the semiconductor wafer 1 can recognized as the target site of measurement and the scribe line 1b of the semiconductor wafer 1 is so positioned by the positioning mechanism 15 that only the scribe line 1b of the semiconductor wafer 1 can be irradiated with the primary X-rays B1 which have been converged by the one-dimensional focusing element 26 such as the elliptic cylindrical reflecting mirror to the line irradiation region of a size not greater than 50 μm. With the scribe line 1b of the semiconductor wafer 1 so measured in the manner described above, the semiconductor wafer 1 can be analyzed non-invasively without the circuit patterned areas 1a being detrimentally damaged by irradiation with the primary X-rays B1, and at an inexpensive cost with no need to use a dedicated semiconductor sample hitherto required solely for the purpose of measurement. Also, the one-dimensional focusing element 26 such as the elliptic cylindrical reflecting mirror is easier to manufacture as compared with the two-dimensional focusing element 6 such as employed in the first embodiment and, therefore, the X-ray fluorescence spectrometer can be assembled at reduced costs.

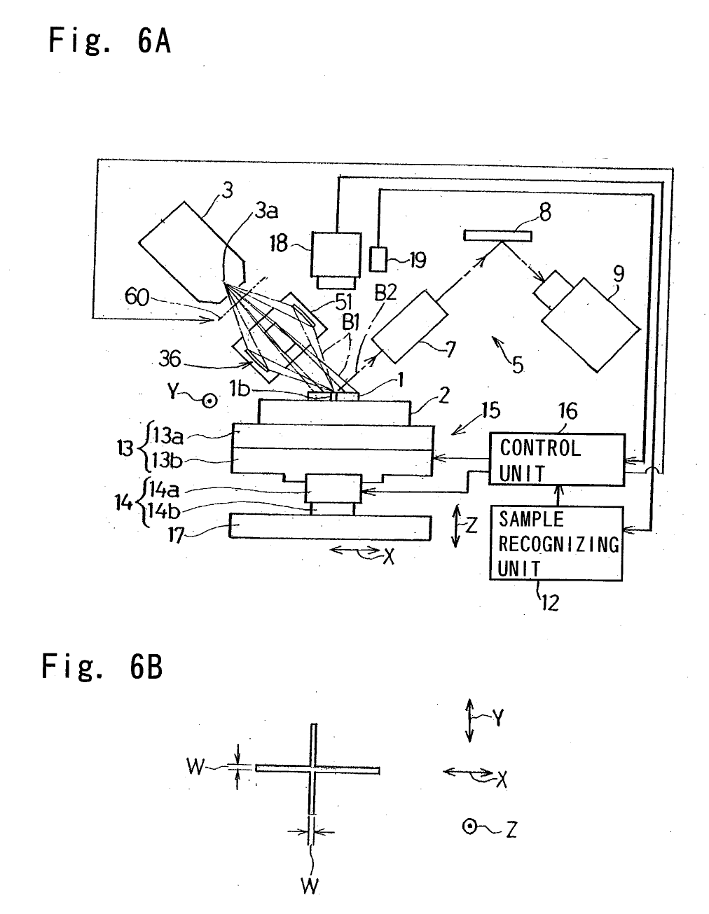

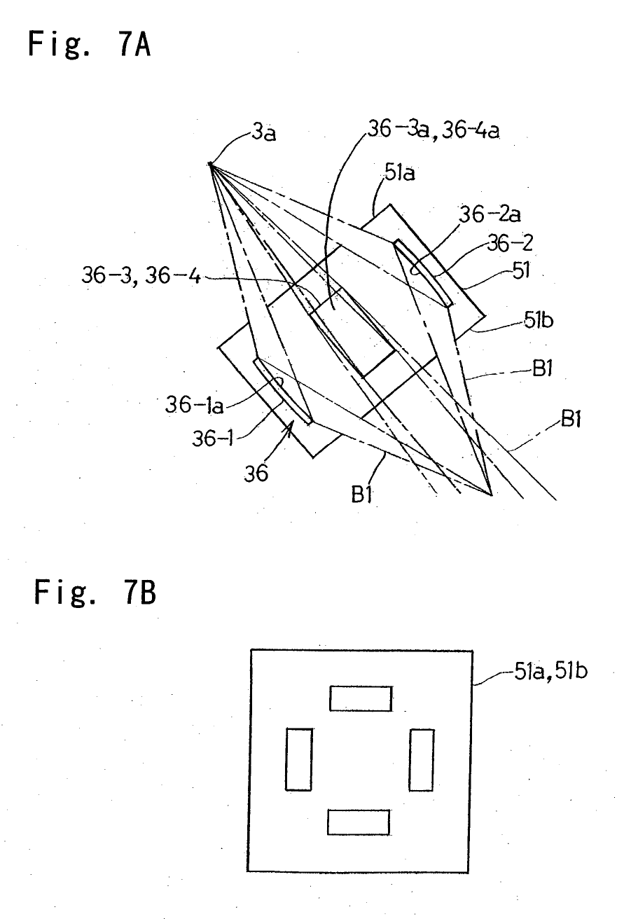

A third preferred embodiment of the present invention will now be described with particular reference to FIGS. 6A to 7B. In the X-ray fluorescence spectrometer particularly shown in FIG. 6A, in place of the two-dimensional focusing element 6 which has been shown and described as employed in the first embodiment, a focusing element 36 is employed of a design effective to focus, as best shown in FIG. 6B, the primary X-rays B1 in a substantially crisscross focus, that is, to form a crisscross irradiation region of the primary X-rays B1 having two line segments of a width W not greater than 50 μm that cross perpendicular to each other. Consequent upon the use of the crisscross focusing element 36, a source of primary X-rays employed therein may be similar to the point source of primary X-rays 3a such as used in the practice of the previously described first embodiment, and other structural features of the X-ray fluorescence spectrometer according to the third embodiment are similar to those of the X-ray fluorescence spectrometer according to the first embodiment and, accordingly, the details thereof will not be reiterated for the sake of brevity.

The crisscross focusing element 36 employed in the practice of the third embodiment of the present invention may be of a design including, as shown in FIG. 7A, two pairs of opposed mirrors or spectroscopic devices 36-1 and 36-2, 36-3 and 36-4 arranged with a direction of confrontation of the opposed mirrors or spectroscopic devices 36-1 and 36-2 lying perpendicular to a direction of confrontation of the opposed mirrors or spectroscopic devices 36-3 and 36-4. In such case, each of the mirrors or spectroscopic devices 36-1 to 36-4 of the focusing element 36 has a respective reflecting surface 36-1a, 36-2a, 36-3a and 36-4a that is an elliptic cylindrical shape or a cylindrical shape approximating to the elliptic cylindrical shape. Where the focusing element 36 is employed in the form of the mirrors and the X-rays from the source of primary X-rays 3a undergoes a total reflection when impinging upon the corresponding reflecting surface 36a because of a small angle of incidence thereof on the reflecting surface 36a, the shape of the reflecting surface 36a may be a sphere approximating to the elliptic cylinder.

The focusing element 36 of the structure described above is encased within a casing 51 of, for example, a box-shaped configuration. As shown in FIG. 7B, this casing 51 has its top and bottom surfaces provided with respective shielding plates 5la and 51b each having four rectangular windows (slits) to avoid the X-rays, emitted by the source of primary X-rays 3a, from irradiating the semiconductor wafer 1 directly without being reflected.

By way of example, the focusing element 36 of the design including the two pairs of opposed elliptic cylindrical reflecting mirrors 36-1 and 36-2, 36-3 and 36-4 has reflecting surfaces 36-1a, 36-2a, 36-3a and 36-4a each being of a shape occupying a portion of an elliptic cylinder that extends in a direction perpendicular to the plane of the sheet of the drawing, such that the X-rays emitted from the point source of primary X-rays 3a (one of the foci) can, after having been reflected by the elliptic cylindrical reflecting surfaces 36-1a, 36-2a, 36-3a and 36-4a, be converged as the primary X-rays B1 at the surface (the other of the foci) of the scribe line 1b of the semiconductor wafer 1 then held at the measurement position. The primary X-rays B1 emitted from the point source of primary X-rays 3a and subsequently through the focusing element 36 are converged at the surface of the scribe line 1b of the semiconductor wafer 1, where they are focused, to represent a substantially crisscross focus, that is, to represent the crisscross irradiation region having two line segments of a width W approximately equal to the effective focus size (diameter) of the source of primary X-rays 3a.

As discussed above, with the X-ray fluorescence spectrometer according to the third embodiment, the scribe line 1b of the semiconductor wafer 1 can recognized as the target site of measurement and the scribe line 1b of the semiconductor wafer 1 is so positioned by the positioning mechanism 15 that only the scribe line 1b of the semiconductor wafer 1 can be irradiated with the primary X-rays B1 which have been converged by the focusing element 36 such as the elliptic cylindrical reflecting mirrors to the crisscross irradiation region of a line size not greater than 50 μm. With the scribe line 1b of the semiconductor wafer 1 so measured in the manner described above, the semiconductor wafer 1 can be analyzed non-invasively without the circuit patterned areas 1a being detrimentally damaged by irradiation with the primary X-rays B1, and at an inexpensive cost with no need to use a dedicated semiconductor sample hitherto required solely for the purpose of measurement.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. By way of example, while any of the foregoing embodiments of the present invention has been shown and described as applied to the X-ray fluorescence spectrometer of a wavelength dispersion type based on a parallel method, the present invention can be equally applied to the X-ray fluorescence spectrometer of a wavelength dispersion type based on a focusing technique or of an energy dispersion type using a semiconductor detector. Also, while to converge the irradiation region of the primary X-rays, it is desirable for the primary X-rays to be projected onto the semiconductor wafer in a direction at right angles thereto, the primary X-rays may be so projected as to be incident on the semiconductor wafer at an inclined angle such as in any one of the foregoing embodiments depending on the relation in position between both of the X-ray tube and the focusing element and the imaging unit and/or the height measuring unit.

Accordingly, such changes and modifications are, unless they depart from the scope of the present invention as delivered from the claims annexed hereto, to be construed as included therein.

What is claimed is:

1. An X-ray fluorescence spectrometer which comprises:
a point source of primary X-rays for emitting primary X-rays used to irradiate a semiconductor sample having circuit patterned areas and scribe line so as to separate the neighboring circuit patterned areas;
a detecting unit for detecting fluorescent X-rays emitted from the semiconductor sample;
a focusing element for focusing the primary X-rays to form a spot irradiation region of a diameter not greater than 50 μm;
a sample recognizing unit for recognizing the scribe line on the semiconductor sample as a target site of measurement; and
a positioning mechanism for moving the scribe line on the semiconductor sample to a measurement position where the primary X-rays are focused.

2. The X-ray fluorescence spectrometer as claimed in claim 1, wherein the focusing element comprises a poly-capillary.

3. The X-ray fluorescence spectrometer as claimed in claim 1, wherein the focusing element comprises a mirror having a reflecting surface of a spheroidal or troidal shape.

4. The X-ray fluorescence spectrometer as claimed in claim 1, wherein the focusing element comprises two mirrors arranged to form a Kirkpatrick-Baez type focusing optics.

5. The X-ray fluorescence spectrometer as claimed in claim 1, wherein the focusing element comprises a spectroscopic device having a reflecting surface of a spheroidal or troidal shape.

6. The X-ray fluorescence spectrometer as claimed in claim 1, wherein the focusing element comprises two spectroscopic devices arranged to form a Kirkpatrick-Baez type focusing optics.

7. An X-ray fluorescence spectrometer which comprises:
a source of primary X-rays for emitting primary X-rays used to irradiate a semiconductor sample having circuit patterned areas and scribe line so as to separate the neighboring circuit patterned areas;
a detecting unit for detecting fluorescent X-rays emitted from the semiconductor sample;
a focusing element for focusing the primary X-rays to form a line irradiation region of a width not greater than 50 μm;
a sample recognizing unit for recognizing the scribe line on the semiconductor sample as a target site of measurement; and
a positioning mechanism for moving the scribe line on the semiconductor sample to a measurement position where the primary X-rays are focused.

8. The X-ray fluorescence spectrometer as claimed in claim 7, wherein the focusing element comprises a mirror having a reflecting surface of a shape selected from the group consisting of an elliptic cylinder, a cylinder and a sphere.

9. The X-ray fluorescence spectrometer as claimed in claim 7, wherein the focusing element comprises a spectroscopic device having a reflecting surface of an elliptic cylindrical shape or a cylindrical shape.

10. An X-ray fluorescence spectrometer which comprises:
a point source of primary X-rays for emitting primary X-rays used to irradiate a semiconductor sample having circuit patterned areas and scribe line so as to separate the neighboring circuit patterned areas;
a detecting unit for detecting fluorescent X-rays emitted from the semiconductor sample;
a focusing element for focusing the primary X-rays to form a crisscross irradiation region having two line segments crossing at right angles to each other, each of said line segments having a width not greater than 50 μm;
a sample recognizing unit for recognizing the scribe line on the semiconductor sample as a target site of measurement; and
a positioning mechanism for moving the scribe line on the semiconductor sample to a measurement position where the primary X-rays are focused.

11. The X-ray fluorescence spectrometer as claimed in claim 10, wherein the focusing element comprises two pairs of opposed mirrors arranged with a direction of confrontation of the opposed mirrors of one pair lying perpendicular to a direction of confrontation of the opposed mirrors of the other pair, each of said mirrors having a reflecting surface of a shape selected from the group consisting of an elliptic cylinder, a cylinder and a sphere.

12. The X-ray fluorescence spectrometer as claimed in claim 10, wherein the focusing element comprises two pairs of opposed spectroscopic devices arranged with a direction of confrontation of the opposed spectroscopic devices of one pair lying perpendicular to a direction of confrontation of the opposed spectroscopic devices of the other pair, each of said spectroscopic devices having a reflecting surface of an elliptic cylindrical shape or a cylindrical shape.
